(19) United States
(12) Patent Application Publication
(10) Pub. No.: US 2014/0180643 A1
(43) Pub. Date: Jun. 26, 2014

(54) COMPUTER IMPLEMENTED METHOD FOR SELECTING A DENTAL PROSTHETIC

(71) Applicant: ANDREW PACINELLI, Wantaugh, NY (US)

(72) Inventor: ANDREW PACINELLI, Wantaugh, NY (US)

(21) Appl. No.: 13/723,577

(22) Filed: Dec. 21, 2012

(51) Int. Cl. G06F 17/30

(52) U.S. Cl. CPC G06F 17/30554
USPC 703/1; 707/722

(57) ABSTRACT

The present invention provides a computer-implemented method for selecting a dental prosthetic comprising entering a set of unique features and measurements of a person into a computer; selecting a set of predetermined identification features from a database, in accordance with a predetermined algorithm; and providing a dental prosthetic in accordance with the set of predetermined identification features.

### CROSS-REFERENCE TO RELATED APPLICATIONS

N/A

### FIELD OF THE INVENTION

The present invention relates, in general, to cosmetic and rehabilitative dentistry, specifically the present invention relates to an individualized computer implemented method of selecting a dental prosthetic for optimal oral-facial aesthetics.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

Cosmetic enhancement in medicine is primarily based on the alteration or creation of structures which are dynamic in nature; examples would include breast augmentation, rhinoplasty, lip enhancement, etc. where the outcome is based on subjective procedures to cosmetically enhance tissues which are dynamic in nature (can and will change over time).

Cosmetic or rehabilitative enhancement in dentistry tries to achieve an aesthetic ideal with the help of all resources available including new technologies. Dentistry, or specifically the restoration of teeth, is one genre of medicine where cosmetic enhancement or oral rehabilitation is based on the fabrication and delivery of a static (unchanging) product or prosthetic. Furthermore, the fabrication of the static prosthetic influences overall facial appearance.

Therefore, there is needed an improved method and computer program for allowing a person to generate an optimal and proportional dental prosthetic for optimal oral-facial aesthetics.

### SUMMARY OF THE INVENTION

The present invention provides a computer-implemented method for selecting a dental prosthetic comprising entering a set of unique features and measurements of a person into a computer; selecting a set of predetermined identification features from a database, in accordance with a predetermined algorithm; and providing a dental prosthetic in accordance with the set of predetermined identification features.

The step of selecting a set of predetermined identification features may include the step of matching said set of unique features and measurements with a plurality of sets of predetermined identification features. Additionally, the step of selecting a set of predetermined identification features may include the step of processing one or more formulas.

The step of providing a dental prosthetic may include the step of generating proportions and measurements for a virtual prosthetic from said one or more formulas.

Additionally, the step of selecting said set of predetermined identification features may include the step of pre-selecting more than one set of said predetermined identification features.

In one particular embodiment, the step of providing a dental prosthetic includes the step of generating a visual model of said dental prosthetic and the step of displaying said visual model on a display. The step of providing the dental prosthetic may also include providing the dental prosthetic as at least one of a definitive dental prosthetic, a temporary dental prosthetic and a solid three-dimensional model. Additionally, the step of providing a dental prosthetic may also include providing said dental prosthetic as at least one of a denture, a veneer, a dental crown, a temporary tooth, a dental filling partial denture, a surgical guide, and/or a dental prosthetic.

The set of unique features of a person may comprise one or more of race, sex, age, skin tone, tooth color, tooth shape, dental measurements, and/or a relative position, size, and/or shape of at least one facial feature. The facial features of a person may include at least one of eyes, eye sockets, nose, ears, cheekbones, chin and/or jaw. Additionally, the unique measurements of a person may comprise at least measurements of at least one tooth, measurements of the intra-oral anatomy of the person, measurements of the persons jaw structures, and/or measurements of the soft tissue and hard tissue.

The predetermined identification features may comprise one or more of race, sex, age, skin tone, tooth color, tooth shape, dental measurements, and/or a relative position, size, and/or shape of at least one facial feature. The facial features comprise at least one of eyes, eye sockets, nose, ears, cheekbones, chin and/or jaw.

Another embodiment of the present invention is directed to a dental prosthetic selection system comprising one or more processors or computers; and one or more memories containing program content executable by said one of more processors or computers. The program content comprises executable content that allow user to enter a set of unique features and measurements of a person, executable content that allow selection from a database, in accordance with a predetermined algorithm, a set of predetermined identification features, and executable content that cause said processor to provide said dental prosthetic in accordance with said set of predetermined identification features.

The program content may includes executable instructions that cause said computer to match said set of unique features and measurements with a plurality of sets of predetermined identification features.

In another embodiment, the program content may include executable content that allows said computer to process one or more formulas. The one or more algorithms may be used to generate proportions and measurements for a virtual prosthetic.

The program content may also include executable instructions that cause said computer to pre-select more than one set of said predetermined identification features.

Additionally, the program content may also include the step of generating a visual model of said dental prosthetic and the step of displaying said visual model on a display. The program content may also include executable instructions that cause said computer to provide the dental prosthetic as at least one of a definitive dental prosthetic, a temporary dental prosthetic or a solid three-dimensional model. The program content may also include executable instructions that cause said computer to provide said dental prosthetic as at least one of a denture, a veneer, a dental crown, a temporary tooth, a dental filling partial denture, a surgical guide, and/or a dental prosthetic.

The unique features of a person may comprises one or more of race, sex, age, skin tone, tooth color, tooth shape, dental measurements, and/or a relative position, size, and/or shape of at least one facial feature. The facial features may comprise at least one of eyes, eye sockets, nose, ears, cheekbones, chin and/or jaw.

The unique measurements of a person may comprise at least measurements of at least one tooth, measurements of the intra-oral anatomy of the person, measurements of the persons jaw structures, and/or measurements of the soft tissue and hard tissue.

The predetermined identification features may include one or more of race, sex, age, skin tone, tooth color, tooth shape, dental measurements, and/or a relative position, size, and/or shape of at least one facial feature. The facial features may comprise at least one of eyes, eye sockets, nose, ears, cheekbones, chin and/or jaw.

Another embodiment of the present invention is directed to a computer readable storage medium containing program content executable by a processor, said program content comprising executable instructions that allow said user to enter a set of unique features and measurements of a person; executable instructions that allow selection of a set of predetermined identification features from a database, in accordance with a predetermined algorithm; and executable instructions that cause said processor to provide a dental prosthetic in accordance with said set of selected predetermined identification features.

### OBJECTS OF THE INVENTION

It is, therefore, one of the primary objects of the present invention to provide a computer-implemented method for selecting a dental prosthetic comprising entering a set of unique features and measurements of a person into a computer; selecting a set of predetermined identification features from a database, in accordance with a predetermined algorithm; and providing a dental prosthetic in accordance with the set of predetermined identification features.

Another object of the present invention is to provide a computer-implemented method for selecting a dental prosthetic that includes the step of matching said set of unique features and measurements with a plurality of sets of predetermined identification features.

Yet another object of the present invention is to provide a computer-implemented method for selecting a dental prosthetic that includes the step of processing one or more algorithms in the step of selecting a set of predetermined identification features.

A further object of the present invention is to provide a computer-implemented method for selecting a dental prosthetic that includes the step of generating proportions and measurements for a virtual prosthetic from said one or more formulas.

Yet a further object of the present invention is to provide a computer-implemented method for selecting a dental prosthetic that includes pre-selecting more than one set of said predetermined identification features.

An additional object of the present invention is to provide a computer-implemented method for selecting a dental prosthetic that includes generating a visual model of said dental prosthetic and displaying said visual model on a display.

Another object of the present invention is to provide a computer-implemented method for selecting a dental prosthetic that includes providing a dental prosthetic as at least one of a definitive dental prosthetic, a temporary dental prosthetic or a solid three-dimensional model.

Yet another object of the present invention is to provide a computer-implemented method for selecting a dental prosthetic that includes the step of providing said dental prosthetic as at least one of a denture, a veneer, a dental crown, a temporary tooth, a dental filling partial denture, a surgical guide, and/or a dental prosthetic.

A further object of the present invention is to provide a dental prosthetic selection system comprising one or more processors or computers; and one or more memories containing program content executable by said one of more processors or computers. The program content comprises executable content that allow user to enter a set of unique features and measurements of a person, executable content that allow selection from a database, in accordance with a predetermined algorithm, a set of predetermined identification features, and executable content that cause said processor to provide said dental prosthetic in accordance with said set of predetermined identification features.

A further object of the present invention is to provide a dental prosthetic selection system containing program content executable by a processor, said program content including executable instructions that cause said computer to match said set of unique features and measurements with a plurality of sets of predetermined identification features.

Yet another object of the present invention is to provide a dental prosthetic selection system containing program content executable by a processor, wherein said program content includes executable instructions that cause said computer to process one or more formulas. The one or more algorithms may be used to generate proportions and measurements for a virtual prosthetic.

A further object of the present invention is to provide a dental prosthetic selection system containing program content executable by a processor, wherein said program content includes executable instructions that cause said computer to pre-select more than one set of said predetermined identification features.

Yet a further object of the present invention is to provide a dental prosthetic selection system containing program content executable by a processor, wherein said program content includes the step of generating a visual model of said dental prosthetic and the step of displaying said visual model on a display.

An additional object of the present invention is to provide a dental prosthetic selection system containing program content executable by a processor, wherein said program content includes executable instructions that cause said computer to provide said dental prosthetic as at least one of a definitive dental prosthetic, a temporary dental prosthetic or a solid three-dimensional model.

Another object of the present invention is to provide a dental prosthetic selection system containing program content executable by a processor, wherein said program content includes executable instructions that cause said computer to provide said dental prosthetic as at least one of a denture, a veneer, a dental crown, a temporary tooth, a dental filling partial denture, a surgical guide, and/or a dental prosthetic.

Another object of the present invention is to provide a computer readable storage medium containing program content executable by a processor, said program content comprising executable instructions that allow said user to enter a set of unique features and measurements of a person; executable instructions that allow selection of a set of predetermined identification features from a database, in accordance with a predetermined algorithm; and executable instructions that cause said processor to provide a dental prosthetic in accordance with said set of selected predetermined identification features.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 illustrates a block diagram of the computer implemented method of dental prosthetic selection.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

It is to be understood that the definition of a dental prosthetic applies to any oral facial prosthetic utilized to replace any hard and soft tissues of the oral cavities and associated hard and soft tissues.

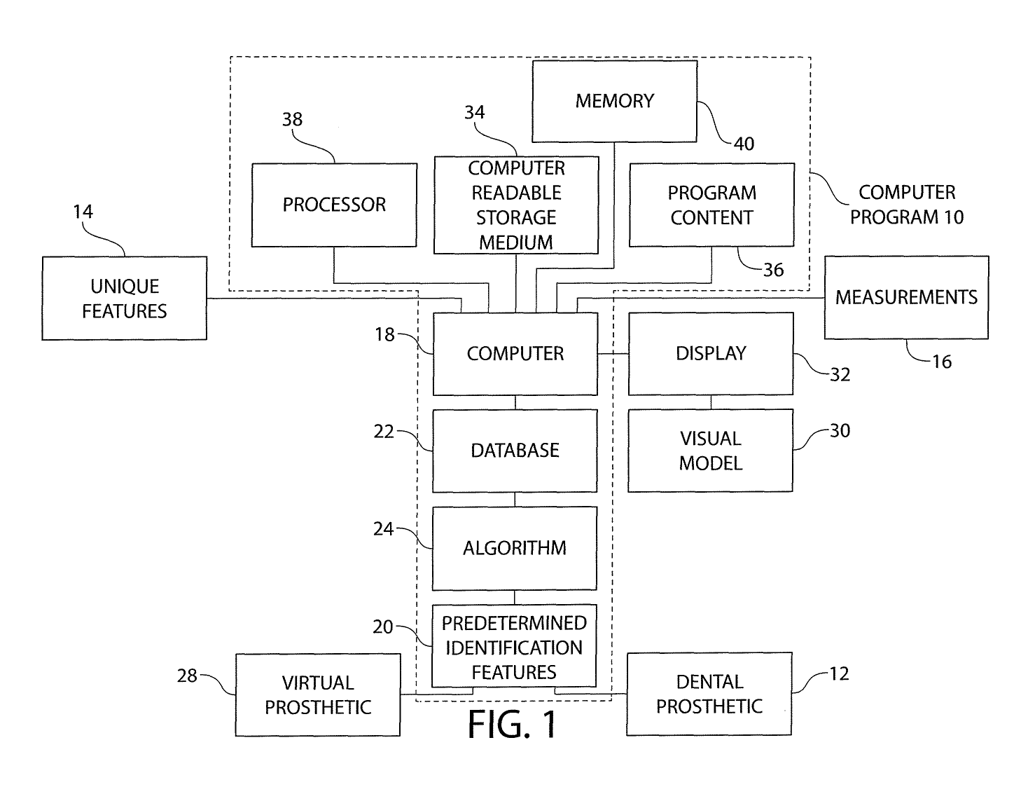

The best mode for carrying out the invention is presented in terms of its presently preferred embodiment, herein depicted within FIG. 1. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

The present invention describes a system and a method for selecting a dental prosthetic (herein described as the “computer program”), generally designated as 10, which provides means to selecting a dental prosthetic.

Reference is now made, to FIG. 1, wherein there is shown a block diagram of the computer-implemented method for selecting a dental prosthetic.

The present invention is illustrated and described in combination with a dental prosthetic, although it will be apparent to those skilled in the relevant art that the present invention may be applied to a plastic and cosmetic surgery selection process and as such should not be interpreted as a limiting factor of the computer implemented method and computer program 10 of the present invention.

According to a first embodiment of the invention, there is provided, a computer-implemented method for selecting a dental prosthetic 12 comprising entering a set of unique features 14 and measurements 16 of a person into a computer 18; selecting a set of predetermined identification features 20 from a database 22, in accordance with a predetermined algorithm 24; and providing a dental prosthetic 12 in accordance with the set of predetermined identification features 20.

The unique features 14 of the person may comprises one or more of race, sex, age, skin tone, tooth color, tooth shape, dental measurements, and/or a relative position, size, and/or shape of at least one facial feature. Any facial feature of an individual may be utilized for example, eyes, eye sockets, nose, ears, cheekbones, chin and/or jaw.

As indicated, measurements 16 of the person may also be entered into the computer. In one embodiment, said measurements comprise at least measurements of at least one tooth, measurements of the intra-oral anatomy of the person, measurements of the persons jaw structures and/or measurements of the person's soft tissue and hard tissue. Particularly, the measurements 16 of the person may be used to determine the appropriate and/or desired proportions of the dental prosthetic and may be acquired by utilizing any known method or technique.

Suitable techniques for capturing a three dimensional anatomy of the oral cavity and/or teeth include intraoral scanning; extra oral capture via CAT scan or Cone Beam scanning; or scanning a stone model of the person and creating a digital file of the persons teeth, tooth arrangement and proportion, and associated hard a soft tissues. Additionally, the hard and soft tissue of the person may be measured and evaluated by any known method, for example, cephalometic analysis. Methods of facial capture and measurements include algorithms consistent with current facial recognition software including geometric, photometric and 3-d facial recognition.

Additionally, the measurements 16 may include facial components, dental components, or a combination thereof. Examples of facial components may include tooth visibility, lip line, smile line, upper lip curvature, negative space, smile symmetry, and/or occlusal line. Examples of dental components may include dental midline, axial alignment, tooth arrangement, gradation, dental morphology, and/or the shape of the teeth.

Once the unique features 14 and measurements 16 are entered into the computer, a set of predetermined identification features 20 are selected from a database 22, in accordance with a predetermined algorithm 24. The predetermined identification features 20 may comprises one or more of race, sex, age, skin tone, tooth color, tooth shape, dental measurements, and/or a relative position, size, and/or shape of at least one facial feature. The facial features comprise at least one of eyes, eye sockets, nose, ears, cheekbones, chin and/or jaw.

The predetermined identification features 20 in the database 22 may be based on anatomic and physiologic data from a “natural” or unaltered population. In one embodiment, the algorithm 24 may be tailored to provide for the design and fabrication of a dental prosthetic 12 which is cosmetically appropriate or optimal for the person based on their entered unique features 14 and measurements 16.

Alternatively, the algorithm 24 may provide for the design and fabrication of a dental prosthetic 12 specifically selected by the person. In this embodiment, the step of selecting said set of predetermined identification features 20 would include the step of pre-selecting more than one set of said predetermined identification features 20. This embodiment may be useful if the person desires a dental prosthetic 12 that provides the person with a smile similar to the smile of another selected individual, for example the smile of a famous individual or celebrity.

In one embodiment of the present invention, the step of selecting a set of predetermined identification features 20 includes the step of matching said set of unique features 14 and measurements 16 with a plurality of sets of predetermined identification features 20. The plurality of sets of predetermined identification features 20 provides the person with multiple options for the dental prosthetic 12.

In another embodiment of the present invention, the step of selecting a set of predetermined identification features 20 may include the step of processing one or more algorithms 26.

In one embodiment of the present invention the step of providing a dental prosthetic 12 may include the step of generating proportions and measurements for a virtual prosthetic 28 from said one or more algorithms 24. The proportions and measurements for the virtual prosthetic 28 may be used to process or mill said dental prosthetic 12 or to generate a static model of said dental prosthetic 12 to be used as a guide for fabrication of the selected dental prosthetic 12 utilizing traditional methods of dental prosthetic fabrication.

In one particular embodiment, the step of providing a dental prosthetic 12 may include the step of generating a visual model 30 of said dental prosthetic 12 and the step of displaying said visual model 30 on a display 32. A display 32 may be defined as any screen or apparatus used to display the output of the computer 18.

The visual model 30 of the dental prosthetic 12 may be a three-dimensional model and may be displayed alone. In an alternative embodiment, the visual model 30 of said dental prosthetic 13 may be displayed on an image of a model person with an appearance similar to said person. Alternatively, the visual model 30 of said dental prosthetic 12 may be displayed on a virtual image of said person 12. The display of the visual model 30 on an image of a model person with an appearance similar to said person or on a virtual image of said person will aid the person in the selection of the desired dental prosthetic 12. The person or a dental professional may select desired dental prosthetic 12.

Once the desired dental prosthetic 12 is selected, a simple algorithm may be used to calculate the dimensions necessary to fit said selected dental prosthetic 12 to said measurements for said person.

In a specific embodiment, the step of providing a dental prosthetic 12 may include the step of providing the dental prosthetic 12 as at least one of a definitive dental prosthetic, a temporary dental prosthetic or a solid three-dimensional model.

Any type of dental prosthetic 12 may be selected from the described method and as previously described, a dental prosthetic 12 may be defined as an oral facial prosthetic utilized to replace hard and soft tissues of the oral cavities and associated hard and soft tissues. In one embodiment, the step of providing a dental prosthetic 12 includes the step of providing said dental prosthetic 12 as at least one of a denture, a veneer, a dental crown, a temporary tooth, a dental filling partial denture, a surgical guide, and/or a dental prosthetic. Additionally, the dental prosthetic 12 may include an oral facial prosthetic, as well as any dental associated prosthetic utilized to replace hard and soft tissues of the oral cavities and associated hard and soft tissues

Another embodiment of the present invention is directed to a dental prosthetic selection system comprising one or more processors 38 or computers 18; and one or more memories 40 containing program content 36 executable by said one of more processors 38 or computers 18. The program content 36 comprises executable content that allow user to enter a set of unique features 14 and measurements 16 of a person, executable content that allow selection from a database 22, in accordance with a predetermined algorithm 24, a set of predetermined identification features 20, and executable content that cause said processor 38 to provide said dental prosthetic 12 in accordance with said set of predetermined identification features 20.

In one particular embodiment, the program content 36 includes executable instructions that cause said computer 18 to match said set of unique features 14 and measurements 16 with a plurality of sets of predetermined identification features 20.

In an alternative embodiment, said program content 36 that allows selection of said predetermined identification features 20 includes executable instructions that cause said computer 18 to process one or more algorithms 24. The one or more algorithms 24 may be used to generate proportions and measurements for a virtual prosthetic 28.

In a particular embodiment, the program content 36 includes executable instructions that cause said computer 18 to pre-select more than one set of said predetermined identification features 20.

In a specific embodiment, the program content 36 includes the step of generating a visual model 30 of said dental prosthetic and the step of displaying said visual model 30 on a display.

In another embodiment, the program content 36 may include executable instructions that cause said computer 18 to provide said dental prosthetic 12 as at least one of a definitive dental prosthetic, a temporary dental prosthetic and a solid three-dimensional model.

In a particular embodiment of the present invention, the program content 36 may also include executable instructions that cause said computer 18 to provide said dental prosthetic as at least one of a denture, a veneer, a dental crown, a temporary tooth, a dental filling partial denture, a surgical guide, and/or a dental prosthetic.

The unique features 14 of a person may comprises one or more of race, sex, age, skin tone, tooth color, tooth shape, dental measurements, and/or a relative position, size, and/or shape of at least one facial feature. The facial features may comprise at least one of eyes, eye sockets, nose, ears, cheekbones, chin and/or jaw.

The unique measurements 16 of a person may comprise at least measurements of at least one tooth, measurements of the intra-oral anatomy of the person, measurements of the persons jaw structures, and/or measurements of the soft tissue and hard tissue.

The predetermined identification features 20 may include one or more of race, sex, age, skin tone, tooth color, tooth shape, dental measurements, and/or a relative position, size, and/or shape of at least one facial feature. The facial features may comprise at least one of eyes, eye sockets, nose, ears, cheekbones, chin and/or jaw.

An alternative embodiment of the present invention is directed to a computer readable storage medium 34 containing program content 36 executable by a processor 38, said program content 36 comprising executable instructions that allow said user to enter a set of unique features 14 and measurements 16 of a person; executable instructions that allow selection of a set of predetermined identification features 20 from a database 22, in accordance with a predetermined algorithm 24; and executable instructions that cause said processor 38 to provide a dental prosthetic 12 in accordance with said set of selected predetermined identification features.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A computer-implemented method for selecting dental prosthetic comprising:
(a) entering, into a computer, a set of unique features and measurements of a person;
(b) selecting from a database, in accordance with a predetermined algorithm, a set of predetermined identification features; and
(c) providing dental prosthetic in accordance with said set of predetermined identification features selected in step (b).

2. The method of claim 1, wherein said step (b) includes the step of matching said set of unique features and measurements with a plurality of sets of predetermined identification features.

3. The method of claim 1, wherein said step (b) includes the step of processing one or more formulas.

4. The method of claim 3, wherein said step (c) includes the step of generating proportions and measurements for a virtual prosthetic from said one or more formulas.

5. The method of claim 1, wherein said step (b) includes the step of pre-selecting more than one set of said predetermined identification features.

6. The method of claim 1, wherein said step (c) includes the step of generating a visual model of said dental prosthetic and the step of displaying said visual model on a display.

7. The method of claim 1, wherein said step (c) includes the step of providing said dental prosthetic as at least one of a definitive dental prosthetic, a temporary dental prosthetic or a solid three-dimensional model.

8. The method of claim 1, wherein said step (c) includes the step of providing said dental prosthetic as at least one of a denture, a veneer, a dental crown, a temporary tooth, a dental filling partial denture, a surgical guide, and/or a dental prosthetic.

9. The method of claim 1, wherein said set of unique features of a person comprises one or more of race, sex, age, skin tone, tooth color, tooth shape, dental measurements, and/or a relative position, size, and/or shape of at least one facial feature.

10. The method of claim 1, wherein said unique measurements of a person comprise at least measurements of at least one tooth, measurements of the intra-oral anatomy of the person, measurements of the persons jaw structures, and/or measurements of the soft tissue and hard tissue.

11. The method of claim 1, wherein said predetermined identification features comprises one or more of race, sex, age, skin tone, tooth color, tooth shape, dental measurements, and/or a relative position, size, and/or shape of at least one facial feature.

12. The method of claim 9, wherein said facial features comprise at least one of eyes, eye sockets, nose, ears, cheekbones, chin and/or jaw.

13. A dental prosthetic selection system comprising:
(a) one or more processors or computers; and
(b) one or more memories containing program content executable by said one of more processors or computers, said program content comprising:
i. executable content that allow user to enter a set of unique features and measurements of a person,
ii. executable content that allow selection from a database, in accordance with a predetermined algorithm, a set of predetermined identification features, and
iii. executable content that cause said processor to provide said dental prosthetic in accordance with said set of predetermined identification features.

14. The dental prosthetic selection system of claim 13, wherein said step (b)(ii) includes executable instructions that cause said computer to match said set of unique features and measurements with a plurality of sets of predetermined identification features.

15. The dental prosthetic selection system of claim 13, wherein said step (b)(ii) includes executable instructions that cause said computer to process one or more formulas.

16. The dental prosthetic selection system of claim 15, wherein said step (b)(iii) includes executable instructions that cause said computer to generate proportions and measurements for a virtual prosthetic from said one or more formulas.

17. The dental prosthetic selection system of claim 13, wherein said step (b)(ii) includes executable instructions that cause said computer to pre-select more than one set of said predetermined identification features.

18. The dental prosthetic selection system of claim 13, wherein said step (b)(iii) includes the step of generating a visual model of said dental prosthetic and the step of displaying said visual model on a display.

19. The dental prosthetic selection system of claim 13, wherein said step (b)(iii) includes executable instructions that cause said computer to provide said dental prosthetic as at least one of a definitive dental prosthetic, a temporary dental prosthetic or a solid three-dimensional model.

20. A computer readable storage medium containing program content executable by a processor, said program content comprising:
(a) executable instructions that allow user to enter a set of unique features and measurements of a person;
(b) executable instructions that allow selection from a database, in accordance with a predetermined algorithm, a set of predetermined identification features; and
(c) executable instructions that cause said processor to provide a dental prosthetic in accordance with said set of predetermined identification features selected in step (b).
